(19) United States
(12) Patent Application Publication
(10) Pub. No.: US 2010/0281919 A1
(43) Pub. Date: Nov. 11, 2010

(54) Device and Method for Shaping Optical Components

(75) Inventors: Darrel Bailey, Gilbert, AZ (US); Gary Kackley, Fostoria, OH (US)

Correspondence Address: THE MUELLER LAW OFFICE, P.C., 12951 Harwick Lane, San Diego, CA, 92130, US

(73) Assignee: SOLFOCUS, INC., Mountain View, CA (US)

(21) Appl. No.: 12/436,772

(22) Filed: May 6, 2009

(51) Int. Cl. C03B 18/18; C03B 11/00

(52) U.S. Cl. 65/29.19; 65/157; 65/32.1

(57) ABSTRACT

The present invention is directed to a device and method for shaping optical components with improved uniformity and higher throughput. A curved oven provides a plurality of sequential chambers arranged in a curved path, with walls separating the chambers. The walls of the chambers may have openings shaped to match the profile of shaping molds and pedestals which are transported through the oven. An optional dual temperature control system may provide for the separate temperature regulation of upper and lower regions of the chambers. Optical components, such as for solar energy sytems, are manufactured by conveying material and molds on a transport system through the curved oven and shaping them by controlled heat and vacuum assisted slumping. The chambers may be grouped into regions, with the materials undergoing different processes as they traverse each region.

### BACKGROUND OF THE INVENTION

Solar energy systems are used to collect solar radiation and convert it into useable electrical energy. Concentrated solar energy devices often comprise a primary mirror used to collect and concentrate solar radiation. The mirror may be comprised of any formable material such as glass, metal or plastic and must be made with sufficient precision to direct incoming solar radiation to, for example, a solar cell or a secondary mirror for further concentration. The present invention relates to a method and apparatus for shaping optical components such as a primary mirror of concentrating photovoltaic devices.

A conventional glass shaping apparatus typically includes two rigid molds—a male mold and female mold—which are brought together to conform a heated sheet of glass positioned there between to the shape of the two molds during the press cycle of the bending process. Other methods of manufacturing curved glass components include slump bending in which a heated glass sheet may be held in a single mold and heated to a temperature above the transformation point of the glass. At that point the sheet partially conforms to the shape of the holder. Alternative methods of shaping glass include the vacuum assisted slumping of glass in a single mold which involves the use of negative pressure to facilitate the slumping of glass into the mold. These processes may cause deformations or buckles to form in the final glass component. In addition to the limitations on the quality of the glass produced by conventional glass shaping techniques, there are numerous process controls. For instance, when male and female molds are used, they require accurate alignment which can take up to two hours. Furthermore, the two rigid molds of the conventional glass bending apparatus require substantially perfect alignment of the heated sheet of glass between the two molds which may further slow down the throughput.

Vacuum slumping may reduce the occurrence of manufacturing defects, but imprecise or uneven temperature control in the heating process may lead to defects regardless of the shaping technique. In addition, the process of loading the glass sheet into a mold, heating, vacuum slumping and removal of the curved glass from the mold may be a slow process, leading to uneven cooling of the mold and an overall low throughput in the manufacturing process. There are other slumping methods which utilize a linear oven for slumping of very large parts, i.e. windshield glass. However, while this process produces larger volumes than individual single ovens, it cannot produce parts with sufficient precision to be used as optical components for a solar energy system. A rotary design produces more parts, with more precision, and in a much smaller footprint but are generally used for small optical components and a press molding process. Current single ovens for one at a time production of large parts and current conveyors utilize different processes that may not be suited for all thicknesses of material. Inaccurate temperature control of current methods may cause re-boiling of the glass being shaped, resulting in the warping of the final product. There exists a need in the art for a high throughput method to manufacture precision shaped optical components in an economical fashion.

### SUMMARY OF THE INVENTION

A method and apparatus are provided for shaping sheets of material in a high throughput manner. Other objects and many of the attendant advantages will be readily appreciated as the subject invention becomes better understood by reference to the following detailed description.

A curved oven and method for using the oven are described for manufacturing a shaped material for optical components by vacuum assisted slumping. The curved oven of the present invention provides a plurality of sequential chambers arranged in a curved path, with entrance and exit apertures and walls separating the chambers. The chambers may have an upper and a lower region, and the walls of the chambers may have openings shaped to match the profile of molds and pedestals being transported through the oven. An optional dual temperature control system may provide for the separate temperature regulation of the upper and lower regions of a chamber. Molds mounted on pedestals may be conveyed through the chambers on a transport system such a rotatable turntable. The design of the oven provides for improved control of the temperature of molds and materials that pass through the oven by reducing the heat loss of molds used to shape materials. The improved control of the molds may improve the consistency, precision, and throughput rate of the manufactured optical components. A vacuum system provides for the application of negative pressure in a portion of the chambers of the oven. The directed application of a vacuum in a portion of the oven chambers may result in an improved consistency and precision of the shaped optical component.

### BRIEF DESCRIPTION OF THE FIGURES

FIG. 1 depicts a schematic view of one embodiment of the curved oven of this invention.

FIG. 2 shows a top cut-away view of one embodiment of the curved oven of this invention.

FIG. 3 depicts schematic view of one embodiment of an oven chamber, pedestal and mold.

FIG. 4 is a work-flow diagram depicting an embodiment of the method of this invention.

### DETAILED DESCRIPTION

The present invention will now be described more fully herein with reference to the accompanying drawings. While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

By use of the method and device of this invention, precisely shaped optical components may be manufactured in a high throughput manner. The optical components may be made from sheet glass or any other moldable material such as plastic. The optical components may be used in a solar energy device, such as a concentrated photovoltaic energy device. The material may be placed in a mold and conveyed by a transport system through a curved oven. The optical components may be manufactured from material of any thickness. In one embodiment, the thickness of the material used to form the optical components may be less than 3 mm. The temperatures of the material and mold may be precisely and separately controlled resulting in improved consistency of the final optical component.

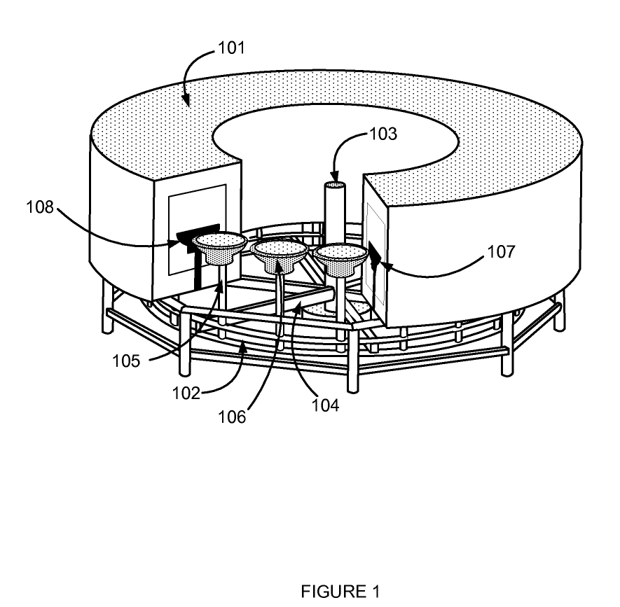

FIG. 1 shows a schematic view of an exemplary device of this invention. The device comprises an oven 101 that conveys molds 106 on a transport system 102 into the oven entrance 107 and out the oven exit 108. The amount that the mold 106 cools as it is conveyed from the oven exit 108 to the oven entrance 107 is reduced due to the limited time spent by the mold outside of the oven between exiting and re-entering. This results in a more consistent mold temperature and an improvement of the quality of the final optical component to be manufactured. Temperature and vacuum control features within the oven may also enable improved quality and throughput of the shaped optical components. The oven 101 may be any shape such as circular, elliptical or other curved configurations. In one embodiment the oven is circular in shape and has a diameter of less than 15 feet.

In the embodiment of FIG. 1, the transport system is a rotatable turntable 102 that rotates about a single central axis 103 supported by radiating spokes 104. The rotatable turntable 102 may be driven by a driving device such as an electric motor (not shown). Alternatively the transport system may be a chain driven tracked path. Hollow pedestals 105 are connected to the transport system and may be conveyed though the curved oven 101 along a path. Individual molds 106 are mounted on the pedestals 105. The molds 106 may be fluidly connected at a lower opening to the hollow pedestals 105. The path of the rotatable turntable 102 leads into an entrance aperture 107, through the oven 101 and out an exit aperture 108. The apertures 107, 108 may be shaped substantially like the profiles of the molds 106 and pedestals 105 to beneficially reduce the amount of heat loss from the oven 101 as the transport system conveys the molds 106 and pedestals 105 through the oven 101. The shape of the apertures 107, 108 may be, for example, 10% greater, 5% greater, or a smaller percentage greater than the profile of the pedestal 105 and mold 106 conveying through the curved oven 101. The pedestals 105 may rotate about their individual pedestal axis as they are conveyed through the path. The pedestal rotation may be controlled by any means such as a cog and chain mechanism that engages when the pedestals 105 are in the curved oven 101. In one embodiment, the pedestal 105 may be connected to a cog (not shown) that engages a chain at portions of the path of the rotatable turntable 102. The rotation may be controlled by means of an ‘engage/disengage’ device (e.g., a chain sprocket) so that mold rotation may be modified along the path of the transport system. The rotation may be globally adjustable to any speed, for example from 1 to 15 revolutions per minute (RPM). Note that other embodiments for coupling molds 106 and pedestals 105 to the transport system are possible, such as with intervening joints. Additionally, pedestal 105 may take other forms such as a solid rod, a cylindrical base, or multiple supports.

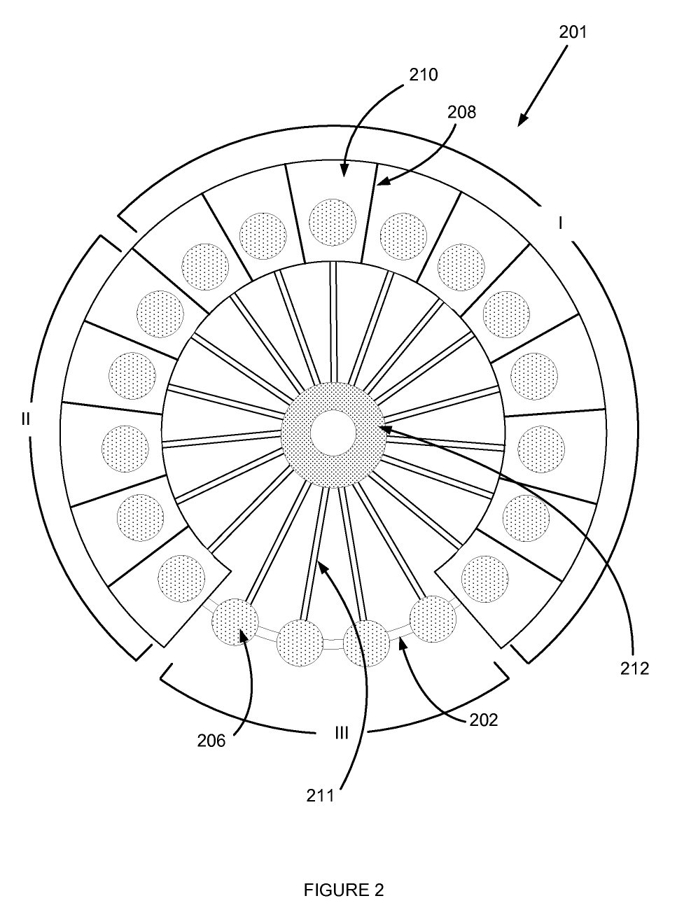

A top view of a curved oven 201 is shown in FIG. 2 indicating an embodiment of the distribution of space inside and outside of the oven 201 along the transport path. The path of the transport system 202 may carry molds 206 through any number of ‘zones’ 210 or areas approximately the size of the molds 206 being conveyed. There may be any number of zones 210 in the device of this invention. A first portion of the zones 210 may be inside the curved oven 201 and the remaining zones 210 may lie outside of the curved oven. The zones 210 within the oven 201 may be divided into separate chambers with defining walls 208. There may be any number of chambers, or zones 210, in the device of this invention. The chambers may be equipped with one or more temperature control devices. The zones 210 may be grouped into regions (I, II, III) where different processes in the component production are performed. There may be any number of regions or processes occurring along the transport path. The walls 208 along the path of the transport system 202 inside the oven may also have apertures shaped substantially like the profile of the molds and pedestals being conveyed by the carrying device (see apertures 107, 108 of FIG. 1). Apertures shaped to match the profile of the molds and pedestals may beneficially control the temperature in the separate chambers by minimizing the heat flow between chambers. The chambers may accommodate equidistantly spaced pedestals and molds. The transport system 202 may convey the molds 206 through the chambers 210 sequentially. The transport system 202 may support any number of pedestals and molds 206. In one embodiment there may be 19 pedestals connected to the transport system 202. Vacuum lines 211 may extend from a vacuum source 212 to the individual molds 206. In one embodiment the application of vacuum may be controlled by a swivel valve in the pedestals so that a negative pressure flows into molds 206 as they are conveyed through a specified portion of the zones 210. A swivel valve may enable the pedestals to rotate about their axis while a vacuum is drawn through the pedestal to the connected mold. In one embodiment, the molds 206 and materials to be shaped may be heated as they pass though region I. The material in molds 206 may be shaped by vacuum slumping in region II, and the shaped material removed and the molds reloaded in region III.

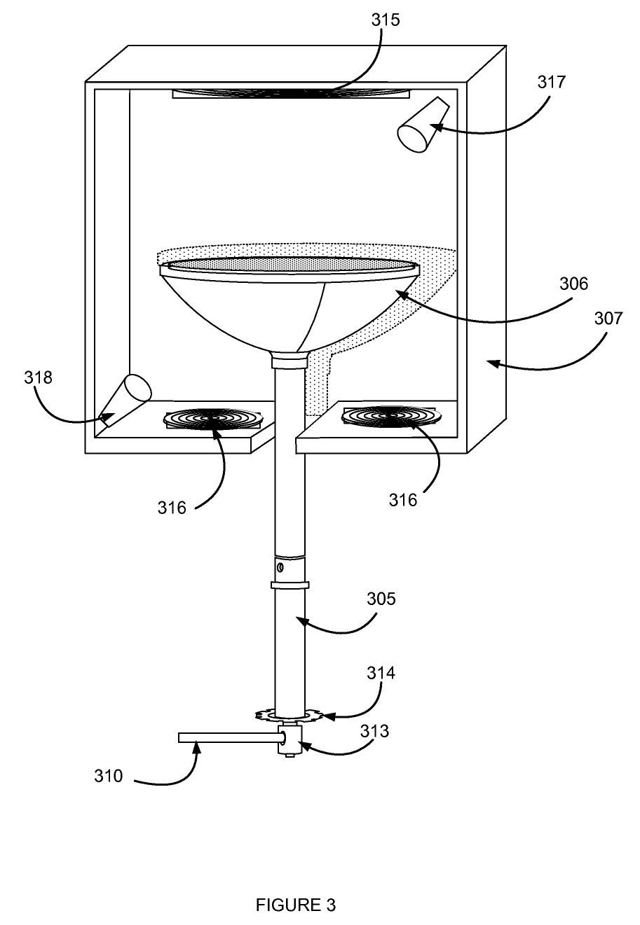

A schematic version of a pedestal 305 and mold 306 in a chamber 307 of one embodiment of this invention is shown in FIG. 3. This embodiment may comprise a dual temperature control system for separate control of the mold and material temperature as they are conveyed through the oven. The chamber 307 may be located in any portion of the oven of this invention. The mold 306 may be fluidly connected to the hollow pedestal 305. A vacuum may be drawn from the vacuum line 310 and connected to the pedestal 305 via a swivel valve 313 and into the mold 306 where a sheet of material (not shown) such as glass may be slumped into the mold 306. The swivel valve 313 may enable the pedestal 305 to rotate as it follows the path of the transport system (not shown). The rotation of the pedestal 305 about its own axis may be controlled by any means such as a cog and chain system. A chain may rotate in the opposite direction as the transport system and periodically engage a cog 314 on the pedestal 305. In one embodiment the pedestal 305 may rotate while being conveyed through the oven. In another embodiment the pedestal 305 may not rotate as it is conveyed outside of the curved oven for unloading and reloading. The temperature of the chambers 307 in the oven may be controlled by temperature control systems such a temperature sensor coupled to a heat source. The heat source may be any device known in the art for heating ovens such as medium wave infrared coils or the like. In the embodiment of this invention shown in FIG. 3, the chamber 307 may include one or more top heat sources 315 and one or more bottom heat sources 316. A temperature sensor 317 may be a thermocouple, a radiometer or any means known in the art for measuring temperature. In one embodiment the temperature control system may comprise a temperature controller, not shown. In another embodiment the temperature sensor 317 may be coupled to the heat sources 315 and 316 and to a temperature controller in a closed loop configuration.

In a further embodiment of this invention, a portion of the chambers 307 may have two or more temperature control systems within a single chamber, beneficially providing for a high level of temperature regulation. The chamber 307 may include a top temperature sensor 317 in a closed loop configuration with the top heat source 315, for separately monitoring and controlling the temperature in the top region of the chamber 307. The chamber 307 may also include a bottom temperature control device 318 in a closed loop with the bottom heat sources 316 to control the temperature of the bottom region of the chamber 307. The temperature sensors 317 and 318 may be located anywhere in the chamber 307. A first temperature control system may be located in the top region of a chamber to advantageously control the temperature of the material to be shaped, while a second temperature control system may be located in the lower region of a chamber to separately control the temperature of the mold 306. In this manner the temperature of the material to be shaped may be controlled separately from the temperature of the mold 306, beneficially offering greater control of the shaping process. Separate control of the material to be shaped and the mold for shaping may reduce defects in the slumped material as sufficient heat is provided to the mold to facilitate slumping while the material to be shaped may be maintained close to the transformation point of the material.

In another embodiment, a temperature sensor may be located outside of the entrance aperture (e.g., aperture 107 of FIG. 1) in order to measure the mold temperature as it enters the entrance apertures. A temperature sensor outside of the oven entrance may beneficially provide a means to monitor the mold temperature as it enters the oven and an opportunity to adjust the oven temperature to maintain a desired mold temperature. In other embodiments, a speed controller for the transport system may be incorporated in a feedback loop with the temperature control system to limit the amount of heat loss incurred by the mold outside the oven. For example, the speed controller may adjust the speed of the transport system based on feedback from the entrance temperature sensor located outside of the entrance aperture. In other embodiments the speed controller may operate to limit the amount of time the mold remains outside of the oven.

The present invention provides a method for manufacturing shaped components for optical systems. One aspect of the method of this invention is that the optical components manufactured by the method and device of this invention may be used as primary mirrors in a concentrated solar energy device. In one embodiment the material used to form the optical component may be less than 3 mm thick. In still another embodiment, the material is sheet glass. The shape of the optical component to be manufactured may be defined by the shape of the mold used. In one embodiment the optical component may be a substantially paraboloid. In another embodiment, the shape and diameter may be any size.

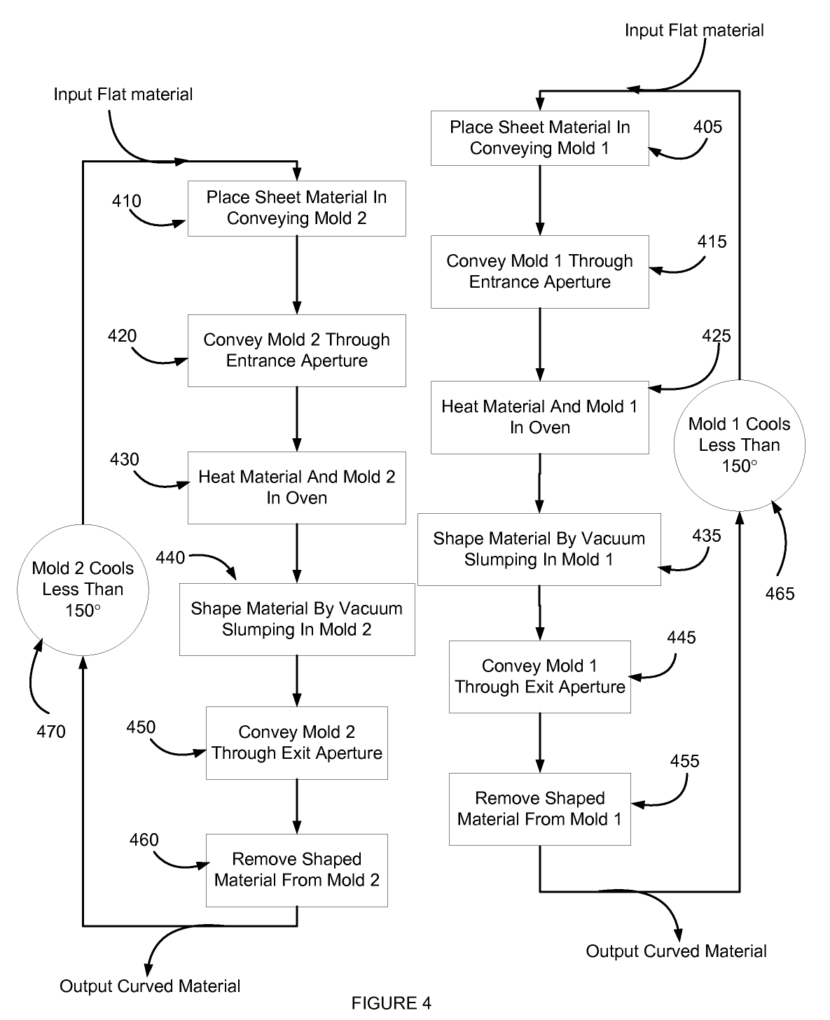

A flow chart depicting an exemplary method of this invention whereby optical components may be manufactured by vacuum assisted slumping in a high throughput manner is shown in FIG. 4. A flat material, for example sheet glass or plastic, is input in the process and a shaped optical component is output. The material to be processed may be any thickness such as between 1 and 4 mm thick, for example 3 mm thick. The right hand column of FIG. 4 shows processing of a first material by a first mold while a second material is simultaneously processed through the oven by a second mold as shown by the left hand column. In step 405, a flat material such as sheet glass or plastic is placed in conveying Mold 1 mounted to a pedestal. The material may be placed in the mold by hand, a robotic arm, winch, or any method known in the art for handling flat materials. Next, in step 410, a second flat material may be placed in conveying Mold 2 as Mold 1 is conveyed through an entrance aperture in step 415. The molds may be mounted on pedestals connected to a transport system that conveys the molds along a closed path. The movement of pedestals and molds along the path by the transport system may be continuous or in a stepped fashion. The speed of transport may be adjustable to any speed, for example two and three meters/minute. In other embodiments, the speed of transport may be adjustable to limit the amount of time the molds are outside the oven, such as a limit of 35 to 60 seconds. Mold 2 may follow through the entrance aperture in step 420. The shape of the entrance aperture may match the profile of the conveying mold and pedestal to beneficially minimize heat loss from the oven and provide a consistent heating environment for the material as it is conveyed through the oven. As the molds enter the curved oven on a transport system, the molds and pedestal may rotate to provide uniform exposure to the heat source. As Mold 1 is conveyed through the curved oven, the first material may be heated by a heat source in sequential chambers as it is conveyed through the curved oven (step 425).

The material may be heated to above the transformation temperature for the material. In step 430 the second material may also be similarly heated in the sequential chambers of a curved oven. The heat in the chamber may be regulated by one or more temperature control systems such as a temperature sensor and heat source connected in a closed loop configuration. In one embodiment the temperature control system may include a first temperature sensor and connected heat source located in the upper region of a chamber and a second temperature sensor and connected heat source located in a lower region of a chamber. Independently heating different portions of the chamber advantageously allows for the separate temperature control of the mold and material to be shaped. The material to be shaped may be heated to a temperature above that of the mold temperature regardless of the mold temperature. At the same time, the mold may be separately heated to a uniform temperature that supports the transformation temperature of the material in a way that may reduce warping as the material is slumped into the mold. The first material may then be shaped by vacuum assisted slumping during step 435. A vacuum source may be connected to an aperture in the mold that is mounted to a hollow pedestal. The pedestal may be connected to a vacuum source via a swivel valve in a manner the permits continuous rotation of the pedestal and mold while the vacuum is engaged. The second material may then be similarly shaped by vacuum assisted slumping in step 440. Molds 1 and 2 are then sequentially conveyed through the exit aperture in steps 445 and 450. The shaped materials are removed during steps 455 and 460. As the molds are reloaded with flat materials, the speed of conveying combined with the distance between the exit and entrance apertures prevents the molds from cooling beyond a desired temperature, such as not losing more than 150 degrees or more than 100 degrees in temperature when working with glass (steps 465 and 470). The control of the uniformity and degree of temperature loss advantageously provide for the high throughput manufacture of shaped optical components.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention, which is more particularly set forth in the appended claims. Furthermore, those of ordinary skill in the art will appreciate that the foregoing description is by way of example only, and is not intended to limit the invention. Thus, it is intended that the present subject matter covers such modifications and variations as come within the scope of the appended claims and their equivalents.

What is claimed:

1. An apparatus for shaping optical components, comprising:
a transport system traversing a curved path wherein the curved path has a first section and a second section;
an oven comprising:
an entrance aperture;
an exit aperture;
a plurality of sequential chambers arranged between the entrance and the exit apertures along the first section of the curved path, wherein the sequential chambers are separated by walls, and wherein the chambers have an upper region and a lower region; and
one or more heating elements located in at least a portion of the sequential chambers;
a plurality of pedestals attached to the transport system, wherein each of the pedestals comprises a vacuum port;
a plurality of molds mounted to the pedestals; and
a vacuum system connected to the vacuum ports, wherein the vacuum system is capable of controlling the application of negative pressure in a portion of the chambers.

2. The apparatus of claim 1, further comprising a temperature control system, wherein the temperature control system comprises a plurality of temperature sensors located in at least a portion of the plurality of the sequential chambers.

3. The apparatus of claim 1, wherein the second section of the curved path is outside of the oven from the exit aperture to the entrance aperture.

4. The apparatus of claim 3, wherein the second section of the of the curved path measures between 2 and 3 meters.

5. The apparatus of claim 1, wherein the walls have apertures with substantially the same profile as the molds mounted on the pedestals.

6. The apparatus of claim 1, wherein the exit aperture and the entrance aperture have substantially the same profile as the molds mounted on the pedestals.

7. The apparatus of claim 1, wherein the transport system is a rotatable turntable.

8. The apparatus of claim 1, wherein the pedestals are rotatable about their own axis.

9. The apparatus of claim 2, wherein the temperature control system comprises a first temperature sensor connected to a first set of one or more of heating elements and second temperature sensor connected to a second set of one or more heating elements.

10. The apparatus of claim 9, wherein the temperature control system comprises a closed loop system.

11. The apparatus of claim 2, wherein the plurality of temperature sensors comprise thermocouples.

12. The apparatus of claim 2, wherein the plurality of temperature sensors comprise radiometers.

13. The apparatus of claim 1, wherein the heating elements comprise medium wave infrared coils.

14. The apparatus of claim 1, further comprising an entrance temperature sensor positioned to monitor the temperature of the mold at the entrance aperture of the curved oven.

15. The temperature sensor device of claim 14, further comprising a speed controller for the transport system, wherein the entrance temperature sensor is connected in a feedback loop with the speed controller.

16. The apparatus of claim 1, further comprising a first temperature control system controlling the temperature in the upper regions of the chambers and a second temperature control system controlling the temperature in the lower regions of the chambers.

17. A method for shaping a material into an optical component in a curved oven having a plurality of walled chambers, wherein the chambers have an upper and a lower region, and wherein the walls of the chambers have apertures, comprising:
placing a first piece of material on a first mold;
conveying the first mold through an entrance aperture in the curved oven;
placing a second piece of material on a second mold;
conveying the second mold through the entrance aperture in the curved oven;
heating the first piece of material to a temperature above the transformation point of the material;
applying a vacuum to the first mold in a portion of the plurality of chambers to shape the first piece of material;
heating the second piece of material to a temperature above the transformation point of the material;
applying a vacuum to the second mold in a portion of the plurality of chambers to shape the second piece of material;
conveying the first mold and the first piece of material through an exit aperture in the curved oven prior to the second mold exiting the curved oven; and
conveying the second mold and the second piece material through an exit aperture in the curved oven.

18. The method of claim 17, wherein the first and second molds are rotating about their own axis while conveying through the curved oven.

19. The method of claim 17, further comprising:
removing the first piece of material from the first mold after conveying the first mold and first piece of material through the exit aperture;
placing a third piece of material in the first mold; and
returning the first mold through the entrance aperture of the curved oven, wherein the first mold cools less than 150 degrees between conveying through the exit aperture and returning through the entrance aperture.

20. The method of claim 19, wherein the distance the first mold is conveyed from the exit aperture to returning to the entrance aperture is less than 3 meters.

21. The method of claim 17, further comprising:
removing the first piece of material from the first mold after conveying the first mold through the exit aperture;
placing a third piece of material in the first conveying mold; and
returning the first mold through the entrance aperture of the curved oven, wherein the amount of time for the first mold to convey from the exit aperture to returning to the entrance aperture is between 35 and 60 seconds.

22. The method of claim 17, further comprising:
conveying the first and second molds through the lower regions of the chambers of the curved oven;
regulating the temperature of the upper region of a portion of the chambers with a first temperature control system; and
regulating the temperature of the lower region of a portion of the chambers with a second temperature control system.

23. The method of claim 17, wherein the molds are conveyed at a speed between 2 and 3 meters/minute.

24. The method of claim 17, wherein the first and second pieces of material are glass.

25. The method of claim 17, wherein the first and second pieces of material are less than 3 mm thick.
